(19) United States
(12) Patent Application Publication
(10) Pub. No.: US 2017/0088439 A1
(43) Pub. Date: Mar. 30, 2017

(54) Removal of Arsenic from Liquids

(71) Applicant: Narayan V. Thakur, San Jose, CA (US)

(72) Inventor: Narayan V. Thakur, San Jose, CA (US)

(21) Appl. No.: 15/275,021

(22) Filed: Sep. 23, 2016

Related U.S. Application Data
(60) Provisional application No. 62/232,457, filed on Sep. 25, 2015.

(51) Int. Cl. C02F 1/28; B01J 20/282; C01G 3/02; B01J 20/06; B01D 15/08; B01D 15/20

(52) U.S. Cl. CPC C02F 1/281; B01D 15/08; B01D 15/203; C01G 3/02; B01J 20/06; B01J 20/282; C02F 2101/103

(57) ABSTRACT

This disclosure provides methods for separation of arsenic, in the form of arsenate and arsenite, from liquids. The method uses CuO as an adsorbent and brings down the arsenic content of liquids, such as water, to less than 10 ppb. This process is cost-effective and applicable for small, medium, and large scale.

### CROSS-REFERENCE TO RELATED APPLICATIONS

This application claims the benefit under 35 U.S.C. §119(e) to U.S. Provisional Application Ser. No. 62/232,457 filed on Sep. 25, 2015, which is hereby incorporated by reference in its entirety.

### FIELD

The present disclosure relates generally to separation of arsenic, in the form of arsenite (As (III)) and arsenate (As(V)), from liquids.

### BACKGROUND

Separation of arsenite and arsenate from liquids presents a challenge. Specifically, separation of arsenite and arsenate from water presents a challenge. The toxicity of arsenic (As) dissolved in water depends on the oxidation state of arsenic in water. Arsenate is reported to be less toxic than arsenite and other forms of arsenic based compounds such as methylated arsenic and the like. The level of arsenic (As) in water beyond 50 ppb (parts per billion) is known to cause carcinogenic effect in human beings. The United States Environmental Protection Agency (EPA), in monitoring the health and environmental concerns regarding arsenic levels in water, has promulgated a new Maximum Contaminant Level (MCL) of 10 ppb in drinking water. Under federal mandates, any water having higher levels of arsenic than the MCL will be found to be unfit and dangerous for human consumption.

The removal of arsenic from water can be accomplished through chemical precipitation of arsenic (As) through addition of lime, alum or an iron salt at an appropriate acidity (pH) to the contaminated water. The combination of the arsenic (As) with lime or salt will cause the arsenic (As) to form an insoluble compound that solidifies or precipitates out of the water for easy removal. Other scientific methods rely on the removal of the ionic form of the element from contaminated water using techniques such as ion exchange, reverse osmosis, electrolysis or distillation. These techniques, which are generally recognized for removing toxic heavy metals from water, are less effective with selenium (Se) and/or arsenic (As) and are especially not applicable for purifying large volume of water due to their associated cost. Therefore, these conventional methodologies are not practical to remove trace amounts of arsenic.

Still other water treatment methods have been employed to achieve acceptable removal of arsenic from contaminated water, including the use of micro particulate iron oxides, iron loaded cation exchange resins; and activated alumina (aluminum oxide or Al₂O₃). These methods are expensive and require labor-intensive process management. Most methods fail to provide a reduction in contaminants sufficient to meet the new United States Environmental Protection Agency or National Science Foundation standards for drinking water.

Use of lanthanum oxide and alumina in separation of arsenite and arsenate from water is discussed in U.S. Pat. No. 5,603,838. However, lanthanum oxide is an expensive chemical. Use of cupric oxide (CuO) in separation of arsenite and arsenate from water is discussed in U.S. Pat. No. 7,897,052. However, the method comprises reacting water with CuO particles for a predetermined time and filtering the reacted water. Also the disclosed method is shown to purify arsenic contaminated water having concentrations of arsenic less than or equal to 1000 ppb. When water containing arsenic is added to the CuO and stirred, it takes more time to adsorb arsenic. Such a method is not suitable even to implement on medium scale production of arsenic-free water. Further, the method requires high quantity of CuO which is expensive, especially to apply on a medium or large scale to purify water.

Thus, there is a great need for a simple, cheap, quick, continuous and easy-to-use alternative method for the separation of arsenite and arsenate, either individually or together, from liquids, such as water that can be used on a large scale.

### SUMMARY

The present disclosure provides a novel flow-through method for separation of arsenic, in the form of arsenite and/or arsenate, from liquids that is quick, easy to use, cheap, continuous and can be used on a large scale. In one embodiment, the liquid is selected from the group consisting of water, wine, alcohol, industrial waste, pharmaceutical products, and health products, or a mixture thereof. In one embodiment, the liquid is a mixture of alcohol and water. In one embodiment, the liquid is water.

In one embodiment, this disclosure provides a flow-through process for separating arsenite and/or arsenate from a first liquid, wherein the process comprises i) passing the first liquid through a composition comprising CuO; and ii) providing a second liquid, wherein the second liquid comprises a level of arsenite and/or arsenate of at least 90% less than level of arsenite and/or arsenate of the first liquid. In other words, the second liquid (i.e. the liquid after passing through CuO) comprises a level of arsenite and/or arsenate which is at most 10% of the level of arsenite and/or arsenate in the liquid before step i) (i.e. the liquid before passing through CuO). In another embodiment, the process further comprises iii) recovering CuO. The first liquid and the second liquid differ in the level of arsenite and/or arsenate they contain. Thus, this process removes at least 90% of arsenic from an arsenic contaminated liquid.

In another embodiment, this disclosure provides a flow-through process for separating arsenite and/or arsenate from water, comprising i) passing the water through a composition comprising CuO; and ii) providing water comprising a level of arsenite and/or arsenate of at least 90% less than level of arsenite and/or arsenate in the water before step i). In other words, the water after passing through CuO comprises a level of arsenite and/or arsenate which is at most 10% of the level of arsenite and/or arsenate in the water before step i) (i.e. the water before passing through CuO). Thus, this process removes at least 90% of arsenic from an arsenic contaminated water. In another embodiment, the process further comprises iii) recovering CuO.

In another embodiment, this disclosure provides a system comprising:
i) a container for a liquid containing arsenic;
ii) a column comprising CuO connected to the container;
iii) a first valve to control flow of liquid from the container to the column; and
iv) a second valve to control flow of arsenic-free liquid from the column to another container.

### DETAILED DESCRIPTION

### Definitions

The following description sets forth exemplary embodiments of the present technology. It should be recognized, however, that such description is not intended as a limitation on the scope of the present disclosure but is instead provided as a description of exemplary embodiments.

As used in the present specification, the following words, phrases and symbols are generally intended to have the meanings as set forth below, except to the extent that the context in which they are used indicates otherwise.

Reference to “about” a value or parameter herein includes (and describes) embodiments that are directed to that value or parameter per se. In certain embodiments, the term “about” includes the indicated amount ±10%. In other embodiments, the term “about” includes the indicated amount ±5%. In certain other embodiments, the term “about” includes the indicated amount ±1%. Also, the term “about X” includes description of “X”. Also, the singular forms “a” and “the” include plural references unless the context clearly dictates otherwise.

The term “comprise” and variations thereof, such as, “comprises” and “comprising” are to be construed in an open, inclusive sense, that is, as “including, but not limited to.” Further, the singular forms “a,” “an,” and “the” include plural references unless the context clearly dictates otherwise.

As used herein, the term “first liquid” refers to a liquid containing arsenic (in the form of arsenite and/or arsenate) before passing it through a composition comprising Cuo. As used herein, the term “second liquid” refers to the liquid obtained after passing it through a composition comprising Cuo. The second liquid comprises lesser amount of arsenic than the first liquid. The second liquid comprises arsenic level of at most 10% of the arsenic level of the first liquid, or at most 5% of the arsenic level of the first liquid, or at most 1% of the arsenic level of the first liquid.

As used herein, the term “industrial scale” refers to large scale and the term “medium scale” refers to the usage in a typical household.

As used herein, the term “flow-through process” refers to a continuous process for separating arsenite and/or arsenate from a liquid. The process involves passing an arsenic contaminated liquid through CuO to provide arsenic-free liquid in a continuous flow.

As used herein, the term “arsenic-free liquid” refers to a liquid comprising arsenic concentration of less than 10 ppb, or less than 9 ppb, or less than 8 ppb, or less than 7 ppb, or less than 6 ppb, or less than 5 ppb, or less than 4 ppb, or less than 3 ppb, or less than 2 ppb or less than 1 ppb.

### Process

In one embodiment, this disclosure provides a flow-through process for separating arsenite and/or arsenate from a first liquid, wherein the process comprises i) passing the first liquid through a composition comprising CuO; and ii) providing a second liquid, wherein the second liquid comprises a level of arsenite and/or arsenate of at least 90% less than the level of arsenite and/or arsenate of the first liquid. In one embodiment, the composition comprising CuO is impregnated into a solid material. In another embodiment, the solid material is a porous solid material. In a further embodiment, the porous solid material is packed in a column, a sealed device, a cartridge or a capsule. The column can be of any shape, such as cylindrical, rectangular, etc. In another embodiment, the composition comprising CuO is packed into a column. In another embodiment, the column comprises a glass tube with a plug (such as cotton or glass wool) on which CuO is added. In another embodiment, the second liquid comprises a level of arsenite and/or arsenate of at least 95% less than the level of arsenite and/or arsenate of the first liquid. In another embodiment, the second liquid comprises a level of arsenite and/or arsenate of at least 99% less than the level of arsenite and/or arsenate of the first liquid. Thus, this process removes at least 90%, or at least 95%, or at least 99% of arsenic from an arsenic contaminated liquid. In one embodiment, the process does not require stirring with CuO or filtration. In another embodiment, the process does not require ion-exchange chromatography. In another embodiment, the process comprises using about one gram of CuO to adsorb about 10 mg of arsenic.

In another embodiment, this disclosure provides a flow-through process for separating arsenite and/or arsenate from a first liquid, wherein the process comprises i) passing the first liquid through a composition comprising CuO; and ii) providing a second liquid, wherein the second liquid comprises a level of arsenite and/or arsenate of at least 90% less than level of arsenite and/or arsenate of the first liquid, wherein the process is continuous.

In another embodiment, this disclosure provides a process, wherein arsenite is separated from the first liquid. In another embodiment, this disclosure provides a process, wherein arsenate is separated from the first liquid. In another embodiment, this disclosure provides a process, wherein both arsenite and arsenate are separated from the first liquid.

In another embodiment, this disclosure provides a flow-through process as described herein, wherein arsenite and/or arsenate are separated from water.

In one embodiment, this disclosure provides a flow-through process for separating arsenite and/or arsenate from a first liquid as described herein, wherein the second liquid comprises a level of arsenite and/or arsenate of at least 99% less than level of arsenite and/or arsenate of the first liquid. In another embodiment, the second liquid comprises an arsenic concentration of about 10 ppb or less.

In one embodiment, this disclosure provides a flow-through process for separating arsenite and/or arsenate from water comprising i) passing the water through a composition comprising CuO; and ii) providing water comprising a level of arsenite and/or arsenate of at least 90% less than level of arsenite and/or arsenate in water before step i). This process works with natural water without requiring adjustment of its pH. In another embodiment, the composition comprising CuO is impregnated into a solid material. In another embodiment, the solid material is a porous solid material. In a further embodiment, the porous solid material is packed in a column, a sealed device, a cartridge or a capsule. The column can be of any shape, such as cylindrical, rectangular, etc. In another embodiment, the composition comprising CuO is packed into a column. In another embodiment, the column comprises a glass tube with a plug (such as cotton) on which CuO is added. In another embodiment, water after step ii) comprises a level of arsenite and/or arsenate of at least 95% less than level of arsenite and/or arsenate of first liquid. In another embodiment, water after step ii) comprises a level of arsenite and/or arsenate of at least 99% less than level of arsenite and/or arsenate of the first liquid. Thus, this process removes at least 90%, or at least 95%, or at least 99% of arsenic from an arsenic contaminated water. In another embodiment, the water after step ii) comprises an arsenic concentration of about 10 ppb or less. In one embodiment, the process does not require stirring with CuO or filtration. In another embodiment, the process does not require ion-exchange chromatography. In another embodiment, the process comprises using about one gram of CuO to adsorb about 10 mg of arsenic.

In one embodiment, this disclosure provides a flow-through process for separating arsenite and/or arsenate from water comprising i) passing the water through CuO; and ii) providing water comprising a level of arsenite and/or arsenate of at least 90% less than level of arsenite and/or arsenate in water before step i). In one embodiment, the CuO is loaded in a column (such as a glass tube) with a plug (such as cotton). The column can be of any shape, such as cylindrical, rectangular, etc. In another embodiment, water after step ii) comprises a level of arsenite and/or arsenate of at least 95% less than level of arsenite and/or arsenate of first liquid. In another embodiment, water after step ii) comprises a level of arsenite and/or arsenate of at least 99% less than level of arsenite and/or arsenate of the first liquid. Thus, this process removes at least 90%, or at least 95%, or at least 99% of arsenic from an arsenic contaminated water. In another embodiment, the water after step ii) comprises an arsenic concentration of about 10 ppb or less. In one embodiment, the process does not require stirring with CuO or filtration. In another embodiment, the process does not require ion-exchange chromatography. In another embodiment, the process comprises using about one gram of CuO to adsorb about 10 mg of arsenic.

In one embodiment, this disclosure provides a flow-through process for separating arsenite and/or arsenate from water consisting essentially of i) passing the water through CuO; and ii) providing water comprising a level of arsenite and/or arsenate of at least 90% less than level of arsenite and/or arsenate in water before step i).

In another embodiment, this disclosure provides a flow-through process for separating arsenic in the form of arsenite and/or arsenate from a liquid as described herein, wherein CuO comprises nanoparticles. The method can also be used for separation of other metals such as lead from liquids such as water.

Use of CuO as nanoparticles is widely known. The common methods for preparing CuO nanoparticles include hydrothermal process and oxalate process. Example 1 discusses one method of preparing CuO nanoparticles. Use of CuO as an adsorbent for arsenic has an added advantage. CuO kills bacterial pathogens. Adsorption of arsenic on CuO depends on the particle size of CuO. If the particle size is small, then the adsorption is better. CuO can be regenerated in this process. The regeneration is very fast by contacting with a base such as NaOH, KOH or the like. The recovery of CuO is almost 100%. Thus, this disclosure provides a process that is very cost effective as it regenerates the CuO in a fast and efficient manner.

In one embodiment, this disclosure provides a flow-through process for separating arsenite and/or arsenate from water, comprising i) passing the water through a composition comprising CuO; ii) providing water comprising a level of arsenite and/or arsenate of at least 90% less than level of arsenite and/or arsenate in water before step i); and iii) recovering CuO by contacting with a base. In one embodiment, the base is NaOH or KOH.

In one embodiment, this disclosure provides a flow-through process, wherein the process is applicable on industrial scale. In another embodiment, this disclosure provides a flow-through process, wherein the process is applicable on a small or medium scale.

In one embodiment, this disclosure provides a system comprising:
i) a container for a liquid containing arsenic;
ii) a column comprising CuO connected to the container;
iii) a first valve to control flow of liquid from the container to the column; and
iv) a second valve to control flow of arsenic-free liquid from the column to another container.

In one embodiment, the arsenic-free liquid in step iv) comprises a level of arsenic of at least 90% less than level of arsenic in the liquid in step i). In one embodiment, the arsenic-free liquid in step iv) comprises a level of arsenic of at least 95% less than level of arsenic in the liquid in step i). In another embodiment, the liquid free from arsenic, in step iv), comprises a level of arsenic of at least 99% less than level of arsenic in the liquid in step i). Thus, this system removes at least 90%, or at least 95%, or at least 99% of arsenic from an arsenic contaminated liquid. In another embodiment, the arsenic-free in step iv) comprises an arsenic concentration of about 10 ppb or less. In another embodiment, the liquid is water. In another embodiment, the container in step i) is an overhead tank.

The process described herein is a continuous process and thus it is a fast process. The process is used with one or more columns or cartridges. The column can be very simple, for example, a glass tube with a plug of cotton. Depending on the amount of arsenite/arsenate in the liquid, one or more columns are used. In one embodiment, only one column is used. The dimensions of the column are adjusted depending on the amount of arsenite/arsenate in the liquid and the volume of the liquid. The process is used with columns or cartridges of variable length, size etc. As the process uses CuO packed in a column or a cartridge, it does not require stirring the CuO in the liquid. Further, once arsenic-free liquid starts coming out from the column or cartridge, then the flow of arsenic-free liquid is continuous.

In one embodiment, the liquid is water. As shown in Example 2 below, starting with water containing 2590 ppb of As, the process described herein provides 8 ppb of arsenic, lower than the MCL of 10 ppb as suggested by the EPA, whereas the method known in the literature provides 34 ppb of arsenic. The results obtained herein are surprising and unexpected. Also, our method does not require activated carbon or ion-exchange resin even for large scale application.

Further, the capacity of CuO to adsorb arsenic can be calculated as shown in Example 6. This information is useful to calculate the quantity of CuO necessary to get the desired production rate of arsenic-free water. In addition it is also useful to find out when CuO is to be recovered from the column. One advantage of the process disclosed is that the recovery of CuO is almost 100% and it uses simple treatment of the column with a base such as NaOH, KOH, or the like as discussed in Example 3.

### Parameters of the Process

Moreover, the efficiency of getting arsenic-free liquid is increased by changing the height and width of the column containing CuO. It was noticed that by increasing the height of the column, the purity of the eluted liquid from the column increases, but it does not increase the rate of production of arsenic-free liquid. To increase the rate of production of arsenic-free liquid, the diameter of the column was increased. More the diameter of the column of adsorbent, better was the rate of production of arsenic-free liquid. Hence, even if the particle size of the adsorbent, such as CuO, is large (which brings down the efficiency of production of arsenic-free water), desired purity can be achieved by adjusting the height of the column. More the particle size of CuO more should be the height of the column of CuO. Hence, by properly adjusting the height and diameter of the column containing the adsorbent, one can adjust the purity and rate of production of arsenic-free liquid.

Example 4 demonstrates how the dimensions of a column can be designed suitable for the removal of arsenic. This process is implemented on a medium scale suitable for household purposes and also suitable for large scale production for a town. Changes in the parameters can be made accordingly as desired from the engineering point of view. Thus, one can initially fix the height of the column to get the desired purity of arsenic from a liquid. Then decide the rate of production of arsenic-free liquid and adjust the diameter of the column. One has to take into consideration the maximum possible arsenic impurity in the liquid. Then decide the maximum height of the CuO in a column to get less than 10 ppb arsenic in liquid after removal of arsenic from the arsenic contaminated liquid. The process can be used on a large scale by using the formula discussed in Example 4. Thus, a plant can be designed to get the desired purity and rate of flow of arsenic-free water using the proper diameter and height of the CuO in the column.

This process is cost effective and maintenance cost is very low. For example, 1 gm CuO adsorbs about 10 mg of arsenic [arsenic (III) and/or arsenic (V)]. Only one gram CuO suffices to purify 4 litres of arsenic contaminated water with a concentration of 2500 ppb arsenic to a concentration of less than 10 ppb of arsenic. The process can be applied on a large scale, for example 100 gm CuO will purify 400 liters of arsenic contaminated water with a concentration of 2500 ppb arsenic to a concentration of less than 10 ppb of arsenic. The process is also applicable to liquids other than water, such as alcoholic drinks, wine, etc. Alcoholic drinks typically contain much less concentration of arsenic such as about 83 ppb or less. One gram of CuO will remove arsenic from about 125 liters of an arsenic contaminated alcoholic drink, typically containing less than 83 ppb of arsenic, to a concentration of less than 10 ppb of arsenic. Additionally, one gram of CuO can be regenerated using about 0.5 gm (or even less) of a base such as NaOH, KOH, or the like. Therefore, the overall process is cost effective because small quantity of CuO is required for this process and CuO can be regenerated using a low cost base such as NaOH, KOH, or the like.

Example 6 demonstrates how the capacity of CuO to adsorb arsenic can be determined. Thus, depending on the volume of water containing arsenic and the amount of arsenic in the water, one can determine the appropriate length of the column for separating arsenic from water. This process of adsorption is economical and the cost of maintenance is negligible. Moreover, CuO kills bacteria, which provides an added advantage. If the same quantity of CuO having filled in the column higher in length, better is the adsorption. This process can be implemented easily for the household purposes as well as on large scale production of removal of arsenic from drinking water.

The process is also useful for removing arsenic from water containing other minerals along with arsenic and in presence of alcohol as demonstrated in Example 5. This process is suitable to remove arsenic from alcoholic drinks, wine, and even from pharmaceutical products.

### EXAMPLES

The materials of the disclosure may be prepared using methods disclosed herein and routine modifications thereof which will be apparent given the disclosure herein and methods well known in the art. Conventional and well-known methods may be used in addition to the teachings herein. The materials described herein, may be accomplished as described in the following examples. If available, reagents may be purchased commercially, e.g. from chemical suppliers. Unless otherwise noted, the starting materials for the following reactions may be obtained from commercial sources.

Examples related to the present invention are described below. In most cases, alternative techniques can be used. The examples are intended to be illustrative and are not limiting or restrictive to the scope of the invention.

### Example 1

### Preparation of CuO Nanoparticles

A solution of 10% aqueous NaOH was prepared and it was added to aqueous CuSO₄ solution till Cu(OH)₂ was completely precipitated at pH of about 9 or above. It was then filtered and washed with water sufficient number of times to remove sulfate ions and then dried in oven at about 160-170° C., for about 4-5 hours to get CuO nanoparticles.

CuO nanoparticles are also prepared using a variety of other methods known in the literature.

### Example 2

### Separation of Arsenite/Arsenate from Water

Arsenic contaminated water was prepared by using about 52 mgs of arsenic (a mixture of arsenite and arsenate) dissolved in about 1.0 liter distilled water and then further diluted with distilled water to get about 2590 ppb arsenic in solution. This water was labeled as sample #1 and was analyzed for its actual arsenic content. Sample #1 is the arsenic contaminated water.

Using the method known in literature (U.S. Pat. No. 7,897,052), arsenic-free water was obtained by separating arsenic from sample #1 as follows: 500 ml of sample #1 was mixed with 3 gm of CuO nanoparticles. The mixture was stirred on magnetic stirrer for about 3 hours. It was then allowed to settle and passed through a filter paper. The sample of clear water that was collected after passing through the filter paper, was labeled as sample #2 and was analyzed for its arsenic content.

Nanoparticles of 1 gm of CuO were loaded in a column. 500 ml of Sample #1 was passed through the column. Water sample coming out of the column in a continuous flow was collected, labeled as sample #3 and was analyzed for its arsenic content. Sample #3 is the arsenic-free water obtained by the method of the present disclosure.

The analysis of the Arsenic content for samples 1, 2 and 3 was as follows:

| Sample # | Arsenic Content |
|---|---|
| 1 | 2590 ppb |
| 2 | 34 ppb |
| 3 | 8 ppb |

Analysis of the above results showed that the arsenic contaminated water (sample #1) was successfully treated by the process disclosed herein. Further, it also showed significant improvement in the removal of arsenic (in the form of arsenite and/or arsenate) from sample #1 by using a column packed with CuO (resulting in sample #3) versus directly adding CuO to it (resulting in sample #2). Also, the process disclosed herein is continuous, does not require stirring and filtering steps, requires significantly less quantity of CuO and provides significantly improved purity of the resulting arsenic-free water. The results obtained are surprising and unexpected. The method disclosed herein provides arsenic-free water containing level of arsenic that is lower than the level suggested by the EPA for drinking water, which is 10 ppb.

### Example 3

### Recovery of CuO

CuO was recovered by removing arsenic adsorbed on the column by passing NaOH or KOH solution and further washing the column with H₂O to remove NaOH or KOH from the column. It was observed that practically no Cu was detected in the eluted fluids of NaOH or KOH or water washings indicating that almost 100% CuO was recovered.

### Example 4

### Separation of Arsenite/Arsenate from Water by Adjusting the Column Dimensions

Starting with arsenic contaminated water containing about 2590 ppb arsenic, the desired rate of production as well as the purity of arsenic-free water (<10 ppb arsenic) was obtained by adjusting the diameter and the height of the column as described below.

A column was filled with 1 gram CuO. The height of CuO in the column was 2 cm and the diameter of the column was 1.2 cm. Using the formula, 3.142 (pi)×r²×h, the volume of CuO in the column was 2.26 cm³ (“r” is the radius of the column in cm and “h” is the height of CuO in the column in cm). The purity of arsenic-free water obtained was <10 ppb arsenic. It is to be noted that the height of CuO in the column determines the purity, whereas the diameter of the column determines the rate of flow of arsenic-free water eluting from the column. Hence, it was decided in further experiment to keep the height constant at 2 cm. In this case the rate of flow of arsenic-free water was only 0.4 ml per minute.

To increase the rate of arsenic-free water, a column of 3.6 cm diameter was used. The weight of CuO used was about 10 grams. It was noticed that the rate of flow of arsenic-free water was about 4 ml per minute. Using the same formula, when a column of 12 cm diameter and height of 2 cm (100 grams of CuO) was used, the rate of arsenic-free water was found to be about 40 ml per minute.

Similarly, when using a column of 2.5 cm diameter was filled with CuO to a height of 14 cm, and water containing 1650 ppb arsenic was passed through the column, purity of arsenic-free water obtained was less than 4 ppb. Thus, this process removes at least 99.7% of arsenic from an arsenic contaminated water.

All these results demonstrate that for getting better purity of arsenic-free water, height of the column is a dominating factor and for getting a better rate flow of arsenic-free water, diameter is the dominating factor.

### Example 5

### Separation of Arsenite/Arsenate from Water Containing Alcohol and Other Minerals

An experiment was conducted to remove arsenic from water containing other minerals along with arsenic and in presence of alcohol as follows.

To 25 ml borewell water containing naturally occurring minerals was added 25 ml of ethanol and 25 ml of arsenic contaminated water (25 ml water containing 2500 ppb arsenic as a mixture of arsenite and arsenate). Thus, the overall solution contained about 833 ppb arsenic. This solution was passed through a column of 1.2 cm diameter containing 1 gram CuO. Height of CuO in the column was 2 cm. The water eluted from the column contained only around 8 ppb arsenic. Thus, in presence of the other natural minerals containing arsenic and in presence of alcohol, arsenic level could be brought down to less than 10 ppb which is the safe limit recommended by EPA.

### Example 6

### Capacity of CuO to Adsorb Arsenite/Arsenate

To determine the capacity of CuO to adsorb arsenic an experiment was conducted as follows: Arsenic solution (70 mg arsenic in 250 ml water) was passed through a column of 1 gram CuO. Arsenic started eluting out from the column after the column of CuO was saturated. The column of CuO was washed with demineralized water to remove unadsorbed arsenic from the column. Further, about 25 ml of 0.1N NaOH was passed through the column to elute the arsenic adsorbed by CuO. The eluted solution was diluted to 100 ml using water and analyzed for arsenic and it was found to contain 106.2 ppm arsenic. Thus, 100 ml eluted solution contained 10620 microgram arsenic. Accordingly, one gram of CuO adsorbs 10.62 mg arsenic.

The adsorption of arsenic depends on particle size of CuO. Smaller the particle size better is the adsorption. Different particle sizes of CuO will adsorb different quantities of arsenic.

It is worth noting that irrespective of the particle size, the adsorbent can be regenerated by NaOH and thus the CuO can be reused after washing it with demineralized water. Moreover, the quantity of NaOH required for regeneration is very small and the process of removal of arsenic from the CuO adsorbent is very fast. Thus, irrespective of the particle size, the process is extremely cost effective.

What is claimed is:

1. A flow-through process for separating arsenite and/or arsenate from a liquid, comprising:
i) passing the liquid through a composition comprising CuO; and
ii) providing a liquid comprising a level of arsenite and/or arsenate of at most 10% of the level of arsenite and/or arsenate in the liquid before step i).

2. The process of claim 1, wherein the liquid is water, wine, alcohol, industrial waste, pharmaceutical products, or health products, or a mixture thereof.

3. The process of claim 1, wherein the liquid is water.

4. The process of claim 1, wherein the composition comprising CuO is impregnated into a solid material.

5. The process of claim 4, wherein the solid material is a porous solid material.

6. The process of claim 5, wherein the porous solid material is packed in a column, a sealed device, a cartridge or a capsule.

7. The process of claim 1, wherein the composition comprising CuO is packed in a column.

8. The process of claim 1, wherein the liquid after step ii) comprises a level of arsenite and/or arsenate of at most 5% of the level of arsenite and/or arsenate in the liquid before step i).

9. The process of claim 1, wherein the liquid after step ii) comprises a level of arsenite and/or arsenate of at most 1% of the level of arsenite and/or arsenate in the liquid before step i).

10. The process of claim 3, wherein the water after step ii) comprises an arsenic concentration of about 10 parts per billion or less.

11. The process of claim 3, wherein the water after step ii) comprises an arsenic concentration of about 8 parts per billion or less.

12. The process of claim 1, wherein CuO comprises nanoparticles.

13. The process of claim 1, wherein the process further comprises:
iii) recovering CuO by contacting with a base.

14. The process of claim 13, wherein the base is NaOH or KOH.

15. The process of claim 1, wherein the process is applicable on industrial scale.

16. A system comprising:
i) a container for a liquid containing arsenic;
ii) a column comprising CuO connected to the container;
iii) a first valve to control flow of liquid from the container to the column; and
iv) a second valve to control flow of arsenic-free liquid from the column to another container.

17. The system of claim 16, wherein the arsenic-free liquid in step iv) comprises a level of arsenite and/or arsenate of at most 5% of the level of arsenite and/or arsenate in the liquid before step i).

18. The system of claim 16, wherein the arsenic-free liquid in step iv) comprises a level of arsenite and/or arsenate of at most 1% of the level of arsenite and/or arsenate in the liquid before step i).

19. The system of claim 16, wherein the liquid free from arsenic, in step iv), comprises an arsenic concentration of about 10 parts per billion or less.

20. The system of claim 16, wherein the liquid is water.
